(19) United States
(12) Patent Application Publication
(10) Pub. No.: US 2017/0015013 A1
(43) Pub. Date: Jan. 19, 2017

(54) Semiautomatic Injector Case O-rings Removal Machine

(71) Applicant: CATERPILLAR INC., Peoria, IL (US)

(72) Inventors: David Alejandro Chairez Briones, Nuevo Laredo (MX); Elisa Michelle Salas Silva, Santa Martha (MX); Mario Eduardo Cuellar Mendoza, Nuevo Laredo (MX)

(73) Assignee: CATERPILLAR INC., Peoria, IL (US)

(21) Appl. No.: 14/800,513

(22) Filed: Jul. 15, 2015

(51) Int. Cl. B26D 1/09; B26D 7/01; B26D 5/08

(52) U.S. Cl. CPC B26D 1/095; B26D 5/08; B26D 7/01

(57) ABSTRACT

A cutting apparatus for removing gaskets from a fuel injector is disclosed. The cutting apparatus includes a blade platform and an actuator for actuating the blade platform. The cutting apparatus also includes a first blade assembly coupled to the blade platform. The first blade assembly may include a first prong and a second prong spaced apart. The cutting apparatus also includes a base platform and an axial position guide coupled to and perpendicular to the base platform. The axial position guide may have an aperture. The cutting apparatus includes an alignment feature aligned to the aperture.

### TECHNICAL FIELD

The present disclosure generally pertains to fuel injectors, and is directed toward an apparatus for removing O-rings from fuel injectors.

### BACKGROUND

Fuel injectors may require maintenance or remanufacture after extensive periods of operation. Such maintenance or remanufacture can involve the removal of seals such as O-rings that surround a fuel injector.

International Patent Publication WO 2011/112390A1 to Villa et al. discloses a cutter that includes a cutting jaw, linkage and a driver for cutting a thru-fastener or a ring from a device. The cutting jaw is configured to cut the thru-fastener from the device. The linkage is coupled to the cutting jaw and configured to convey a force to move the cutting jaw. The driver is coupled to the linkage and configured to apply the force to the linkage.

The present disclosure is directed toward overcoming one or more of the problems discovered by the inventors or that is known in the art.

### SUMMARY OF THE DISCLOSURE

A cutting apparatus for removing gaskets from a fuel injector is disclosed. The cutting apparatus includes a blade platform and an actuator for actuating the blade platform. The cutting apparatus also includes a first blade assembly coupled to the blade platform. The first blade assembly includes a first prong extending away from the blade platform. The first prong may have a first cutting portion. The first blade assembly includes a second prong extending away from the blade platform. The second prong may have a second cutting portion. The second prong may be spaced apart from the first prong. The first blade assembly includes a first slot between the first prong and the second prong. The cutting apparatus also includes a base platform parallel and spaced away from the blade platform. The cutting apparatus includes an outer position guide extending from the base platform. The cutting apparatus includes an axial position guide adjacent and perpendicular to the base platform. The axial position guide may be distal to the outer position guide. The axial position guide may have an aperture defining an axis.

### BRIEF DESCRIPTION OF THE DRAWINGS

FIG. 1 is a perspective view of a cutting apparatus.

FIG. 2 is a cross sectional view of the cutting apparatus of FIG. 1 taken along axis 199.

FIG. 3 is a perspective view of the cutting apparatus of FIG. 1, an enclosure, and a receptacle.

FIG. 4 is a perspective view of an exemplary embodiment of a fuel injector.

FIG. 5 is a flowchart illustrating an exemplary method of removing a gasket from a fuel injector.

### DETAILED DESCRIPTION

The systems and methods disclosed herein include a cutting apparatus for removing gaskets from a fuel injector. The cutting apparatus may include a blade driven by an actuator, in which the blade may include two prongs spaced apart from one another. The cutting apparatus may include a base platform to support the fuel injector. The base platform may include alignment features to align the fuel injector. The actuator may drive the two prongs of the blade to shear a gasket off of the fuel injector.

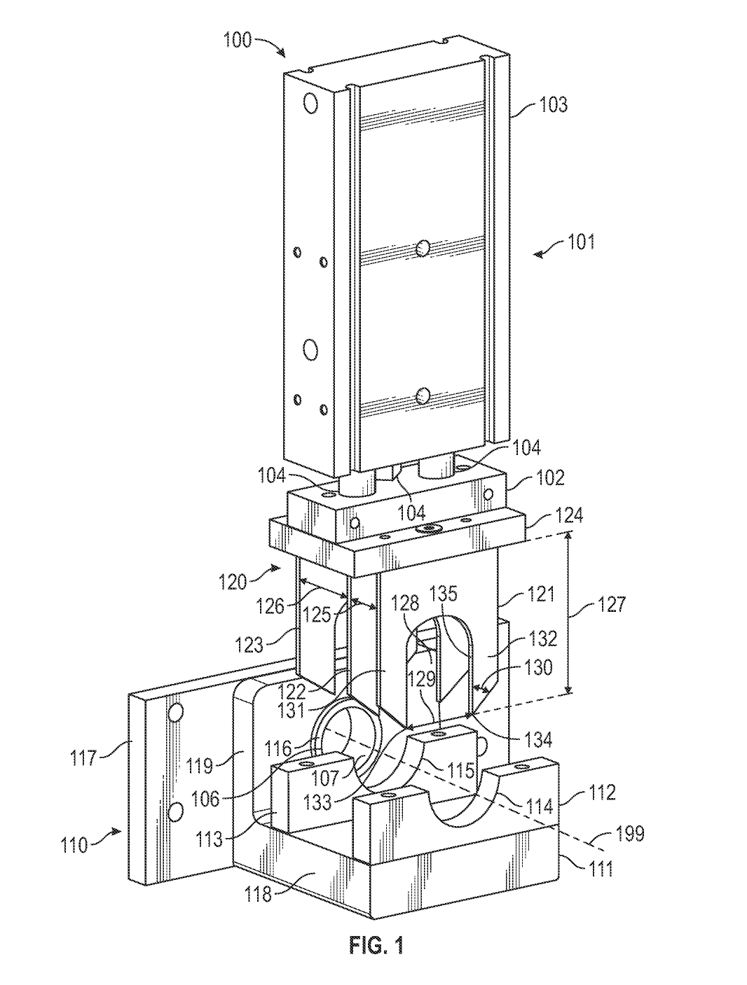

FIG. 1 is perspective view of a cutting apparatus 100. As shown in FIG. 1, cutting apparatus 100 may include an actuator assembly 101, a base assembly 110, and a cutting assembly 120. Components of cutting apparatus 100 may generally be aligned to an axis (sometimes referred to as an assembly axis) 199. All references to radial, axial, and circumferential directions and measures with reference to cutting apparatus 100 and its components are with reference to axis 199.

In some embodiments, actuator assembly 101 includes an actuator 103 and an actuator head 102. Actuator 103 may be a linear actuator that drives a plurality of shafts 104 in a linear direction. In some embodiments, actuator 103 drives a single shaft. The plurality of shafts 104 may be coupled to actuator head 102 in which actuator head 102 is also driven in the same linear direction. In some embodiments, actuator 103 is pneumatically driven. In other embodiments, actuator 103 is mechanically driven, electrically driven, hydraulically driven, or manually driven by an operator (such as a hand crank).

As shown, cutting assembly 120 may include a plurality of blade assemblies (sometimes referred to as cutting tools) such as a first blade assembly 121, a second blade assembly 122, and a third blade assembly 123. Cutting assembly 120 may further include a blade platform 124. Each blade assembly may be coupled to one side of blade platform 124. In some embodiments, each blade assembly is coupled to blade platform 124 by screws, bolts, pins, or the like.

Alternatively, cutting assembly 120 may include more or fewer blade assemblies. In some embodiments, cutting assembly 120 includes at least one blade assembly. In some embodiments, cutting assembly 120 includes at least two blade assemblies. In some embodiments, cutting assembly 120 includes at least three blade assemblies. In some embodiments, cutting assembly 120 includes at least four blade assemblies.

In some embodiments, actuator head 102 of actuator assembly 101 is coupled to a side of blade platform 124 opposite the blades. Actuator head 102 may be coupled to blade platform 124 by screws, bolts, pins, or the like.

Each blade assembly may include two prongs spaced apart from one another to define a slot. For example, first blade assembly 121 may include a first prong 131 and a second prong 132 spaced apart from first prong 131. First prong 131 and second prong 132 may be parallel to one another. First prong 131 and second prong 132 may define a first slot 128. In some embodiments, first slot 128 may have an extended half round shape. In some embodiments, first prong 131 and second prong 132 are collectively formed from one part. In other embodiments, first prong 131 and second prong 132 are each formed from one part.

First prong 131 and second prong 132 may each have a cutting portion. In particular, first prong 131 may have a first cutting portion 133 and second prong 132 may have a second cutting portion 134. First cutting portion 133 may be the terminal end of first prong 131, and second cutting portion 134 may be the terminal end of second prong 132. The end of first cutting portion 133 and the end of second cutting portion 134 may be aligned to a same plane. First cutting portion 133 and second cutting portion 134 may each form a cutting edge adjacent first slot 128. First cutting portion 133 may be oriented at an angle 130 relative to a side 135 of first slot 128. In some embodiments, angle 130 ranges from 49 degrees to 58 degrees. In some embodiments, angle 130 is about 49 degrees. Second cutting portion 134 may be oriented at an angle identical to first cutting portion 133 in an opposite direction.

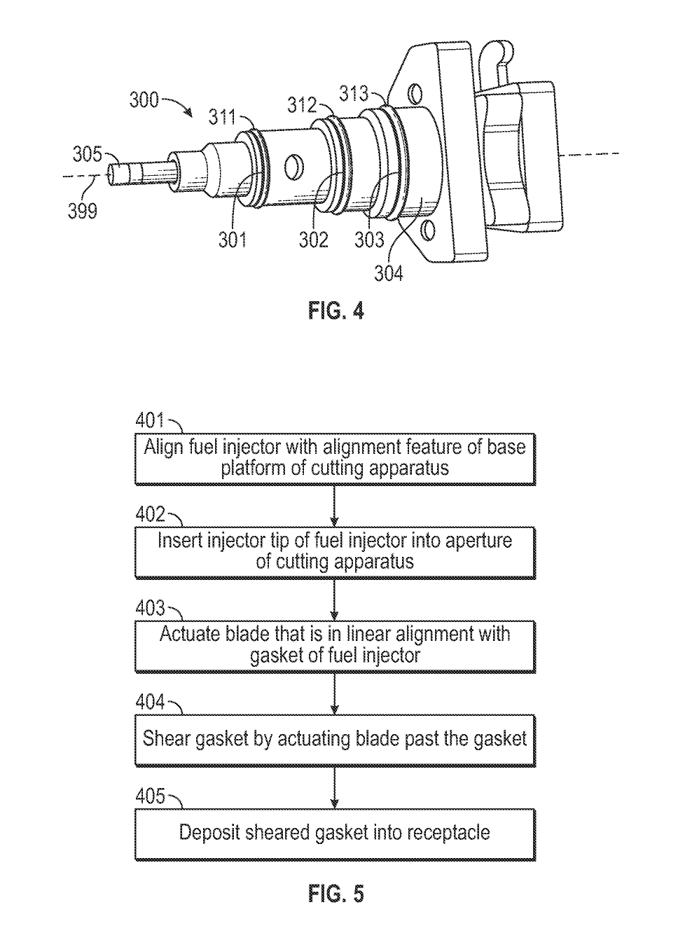

First prong 131 and second prong 132 may be spaced apart a distance 129. In embodiments where first prong 131 and second prong 132 are parallel to one another, distance 129 is the same as the width of first slot 128. In some embodiments, distance 129 is relative to a gasket channel and a gasket of a fuel injector. Furthermore, distance 129 may be great enough to engage opposite sides of a gasket of a fuel injector. For example, distance 129 may be greater than the width of a first ring channel 301 of a fuel injector 300 (shown in FIG. 4). Furthermore, distance 129 may be less than the width of a first ring 311 of fuel injector 300 (shown in FIG. 4).

In some embodiments, distance 129 ranges from 25 mm to 37 mm. In some embodiments, distance 129 is about 37 mm. First blade assembly 121 may have a height 127. In some embodiments, height 127 is about 76 mm.

Second blade assembly 122 and third blade assembly 123 may include similar features as first blade assembly 121. For example, second blade assembly 122 may include at least two prongs, in which the two prongs define a second slot. In addition, third blade assembly 123 may include at least two prongs, in which the two prongs define a third slot. Furthermore, second blade assembly 122 and third blade assembly 123 may include similar dimensions as first blade assembly 121. In other embodiments, first blade assembly 121, second blade assembly 122, and third blade assembly 123 include different dimensions compared to one another. For example, the prongs of second blade assembly 122 may be spaced apart a distance of about 34 mm. In addition, each cutting portion of second blade assembly 122 may have an angle of about 52 degrees.

In some embodiments, first blade assembly 121 is spaced apart from second blade assembly 122 a distance 125 along axis 199. Distance 125 may range from 23 mm to 27.5 mm. In some embodiments, second blade assembly 122 is spaced apart from third blade assembly 123 a distance 126 along axis 199. Distance 126 may range from 36 mm to 39 mm.

Each blade assembly of cutting assembly 120 may be composed of metal, plastic, or a similar rigid material. In some embodiments, each blade assembly is composed of steel.

In some embodiments, base assembly 110 includes a base structure 111, a wall structure 117, an outer position guide (sometimes referred to as an outer mounting wall) 112, an inner position guide (sometimes referred to as an inner mounting wall) 113, and an insert 116. Outer position guide 112 and inner position guide 113 may each be fixtures for supporting a fuel injector. As shown, base structure 111 may be located distal to cutting assembly 120. Base structure 111 may include a base platform 118 and an axial position guide 119. In some embodiments, base platform 118 is a rectangular type structure. In some embodiments, axial position guide 119 is a rectangular type structure. As shown, axial position guide 119 may be adjacent and perpendicular to base platform 118. In addition, axial position guide 119 of base structure 111 may be coupled to wall structure 117.

Outer position guide 112 may be coupled to base platform 118 at an outer end of base platform 118. Furthermore, outer position guide 112 may extend from the top surface of base platform 118. Inner position guide 113 may also be coupled to base platform 118 and may be spaced apart from outer position guide 112 along axis 199. Inner position guide 113 may also extend from the top surface of base platform 118. Outer position guide 112 and inner position guide 113 may each include an alignment feature. In particular, outer position guide 112 may include an outer alignment feature 114 and inner position guide 113 may include an inner alignment feature 115. Outer alignment feature 114 may be located proximal the center of outer position guide 112, and inner alignment feature 115 may be located proximal the center of inner position guide 113. In addition, outer alignment feature 114 and inner alignment feature 115 may both be an indented rounded surface. In some embodiments, outer alignment feature 114 and inner alignment feature 115 are both indented circular surfaces extending into the top surface of outer position guide 112 and inner position guide 113, respectively. In some embodiments, outer alignment feature 114 and inner alignment feature 115 may be referred to as semi-circular apertures extending through outer position guide 112 and inner position guide 113, respectively, in the direction of axis 199. Outer alignment feature 114 and inner alignment feature 115 may be aligned with axis 199. Outer alignment feature 114 may have a radius of about 20 mm, and inner alignment feature 115 may have a radius of about 16 mm.

Axial position guide 119 may include an aperture 106 (hidden behind insert 116) extending through axial position guide 119. In some embodiments, aperture 106 extends partially through axial position guide 119. In some embodiments, aperture 106 extends all the way through axial position guide 119. Insert 116 may be positioned into aperture 106. Insert 116 may include an annular flange and a cylindrical tube extending from the annular flange. The cylindrical tube may include an insert aperture 107. In some embodiments, insert aperture 107 has a diameter of about 29 mm. In some embodiments, insert 116 includes an inner aperture (not shown), in which the inner aperture has a smaller diameter than insert aperture 107.

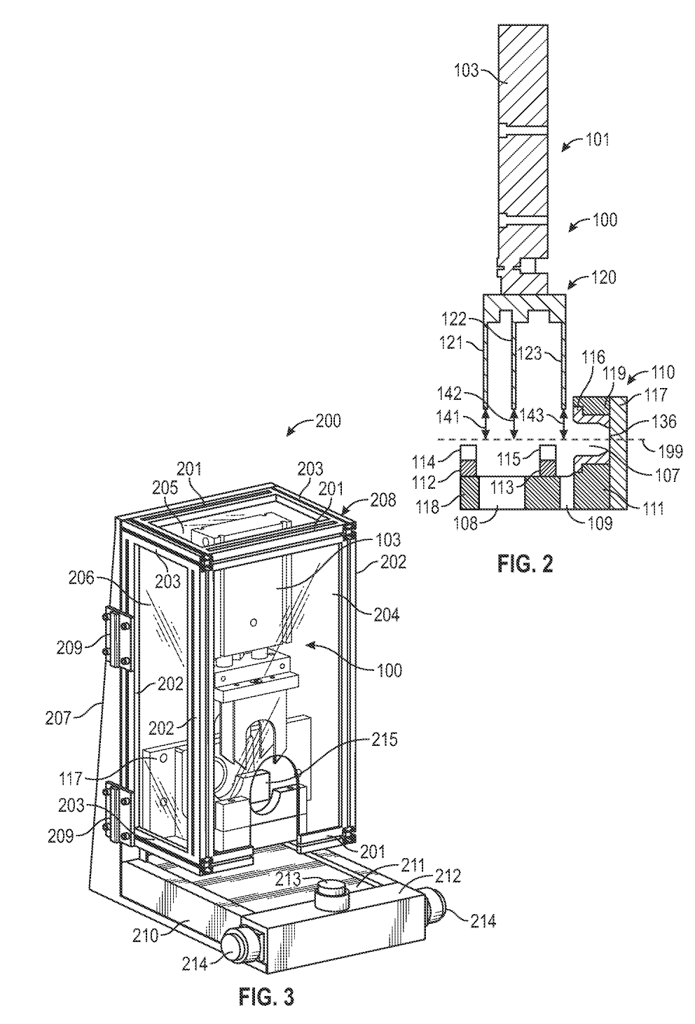

FIG. 2 is a cross sectional view of the cutting apparatus of FIG. 1 taken along axis 199. As shown in the figure, base platform 118 may include an outer base opening 108 and an inner base opening 109. Outer base opening 108 and inner base opening 109 may each extend through base platform 118. Outer base opening 108 and inner base opening 109 may each be a through-hole in base platform 118. In addition, outer base opening 108 may be located adjacent outer position guide 112. In some embodiments, outer base opening 108 may be located between outer position guide 112 and inner position guide 113. Inner base opening 109 may be located between inner position guide 113 and axial position guide 119. In some embodiments, outer base opening 108 has a width (length of outer base opening 108 in the direction of the plane of the page) equal to or greater than the radius of outer alignment feature 114. In other embodiments, outer base opening 108 has a width slightly less than the radius of outer alignment feature 114. In some embodiments, inner base opening 109 has a width (length of inner base opening 109 in the direction of the plane of the page) equal to or greater than the radius of inner alignment feature 115. In other embodiments, inner base opening 109 has a width slightly less than the radius of inner alignment feature 115.

First blade assembly 121 may be positioned axially distal from the outer position guide 112. In some embodiments, first blade assembly 121 is positioned axially between outer position guide 112 and inner position guide 113. Second blade assembly 122 may be positioned axially between outer position guide 112 and inner position guide 113. Third blade assembly 123 may be positioned axially between inner position guide 113 and axial position guide 119.

In some embodiments, axial position guide 119 includes an axial stopping guide 136. Axial stopping guide 136 may be the terminal end of insert aperture 107 (or aperture 106). In addition, axial stopping guide 136 may be spaced a predetermined distance from outer position guide 112 and/or inner position guide 113. In some embodiments, axial stopping guide 136 is a wall or a type of barrier. In some embodiments, axial stopping guide 136 is a circular indented wall.

As shown, each blade assembly may be located at a predetermined position relative to axis 199. In some embodiments, each blade assembly is located at a predetermined position relative to an alignment feature, such as outer alignment feature 114. Each blade assembly may be positioned away from base platform 118 a sufficient distance to allow for insertion of a fuel injector. In addition, the end of each blade assembly may be located a predetermined distance from axis 199. For example, the end of first blade assembly 121 may be located a predetermined distance 141 from axis 199. The end of second blade assembly 122 may be located a predetermined distance 142 from axis 199. The end of third blade assembly 123 may be located a predetermined distance 143 from axis 199. The end of each blade assembly may be a cutting portion. In some embodiments, distance 141, distance 142, and distance 143 are the same. In other embodiments, distance 141, distance 142, and distance 143 are different due to varying heights of the respective blade assembly.

In some embodiments, actuator 103 is configured to actuate each blade assembly a predetermined distance from an initial position. For example, actuator 103 may be configured to actuate first blade assembly 121 the distance of distance 141. Actuator 103 may be configured to actuate second blade assembly 122 the distance of distance 142. Actuator 103 may be configured to actuate third blade assembly 123 the distance of distance 143. In some embodiments, actuator 103 may be configured to actuate each blade assembly a distance greater than their respective predetermined distances. In some embodiments, actuator 103 may be configured to actuate each blade assembly a distance less than their respective predetermined distances. In some embodiments, actuator 103 is configured to actuate each blade assembly from a predetermined position relative to axis 199 to a position past the center of a fuel injector.

FIG. 3 is a perspective view of the cutting apparatus 100 of FIG. 1, an enclosure 200, and a receptacle 210. As shown, cutting apparatus 100 may be assembled within enclosure 200 and receptacle 210 may be located below cutting apparatus 100. In some embodiments, cutting apparatus 100, enclosure 200, and receptacle 210 may collectively be referred to as a gasket removal machine.

Enclosure 200 may include a plurality of frames, a plurality of panels, and a back wall 207. In particular, enclosure 200 may include a plurality of horizontal frames 201, a plurality of vertical frames 202, and a plurality of short horizontal frames 203. The plurality of frames may be coupled together to form rectangular openings, in which one of the plurality of panels may be positioned in each rectangular opening. The plurality of panels may include a front panel 204, a top panel 205, a left panel 206, and a right panel 208 (not visibly shown). Back wall 207 may form the back of enclosure 200. As shown in the figure, front panel 204 may include an enclosure opening 215 extending through front panel 204. Enclosure opening 215 may have an extended half round shape.

Actuator 103 may be coupled to back wall 207. In some embodiments, actuator 103 is coupled to back wall 207 by screws, bolts, pins, or the like. In addition, wall structure 117 may also be coupled to back wall 207. In some embodiments, wall structure 117 is coupled to back wall 207 by screws, bolts, pins, or the like.

In some embodiments, enclosure 200 may include panel hinges coupled to one of the panels. For example, left panel 206 may be coupled to a pair of panel hinges 209. Panel hinges 209 may allow left panel 206 to open and close.

Receptacle 210 may be an elongated member coupled to back wall 207. Receptacle 210 may be coupled to back wall 207 by screws, bolts, pins, or the like. In some embodiments, receptacle 210 includes a recess 211. In addition, receptacle 210 may include an emergency button 213 and two activation buttons 214. Emergency button 213 and activation buttons 214 may be located near an outer end 212 of receptacle 210. Emergency button 213 may be a button connected to actuator 103. Each activation button 214 may be a button connected to actuator 103. In some embodiments, receptacle 210 includes only one activation button 214.

FIG. 4 is a perspective view of an exemplary embodiment of a fuel injector 300. As shown, fuel injector 300 may include a cylindrical body 304, an injector tip 305, a plurality of gasket channels, and a plurality of gaskets. Components of fuel injector 300 may generally revolve around an axis 399. The diameter of cylindrical body 304 may vary along the length of cylindrical body 304. In some embodiments, fuel injector 300 includes at least one gasket channel (sometimes referred to as a ring channel) and at least one annular gasket (sometimes referred to as a ring). In some embodiments, fuel injector 300 includes at least two gasket channels and at least two gaskets. In some embodiments, fuel injector 300 includes at least three gasket channels and at least three gaskets. In some embodiments, fuel injector 300 includes at least four gasket channels and at least four gaskets. In some embodiments, the plurality of gaskets are O-rings.

As shown, fuel injector 300 includes a first ring channel 301, a second ring channel 302, and a third ring channel 303. Fuel injector 300 also may include a first ring 311, a second ring 312, and a third ring 313. Furthermore, first ring 311 may enclose first ring channel 301, second ring 312 may enclose second ring channel 302, and third ring 313 may enclose third ring channel 303.

In some embodiments, injector tip 305 is one end of fuel injector 300. In some embodiments, first ring channel 301 is distal to injector tip 305 along axis 399. Additionally, second ring channel 302 may be distal to first ring channel 301 along axis 399. Third ring channel 303 may be distal to second ring channel 302 along axis 399.

In some embodiments, first ring channel 301, second ring channel 302, and third ring channel 303 each have different diameters. In other embodiments, first ring channel 301, second ring channel 302, and third ring channel 303 each have similar diameters. In some embodiments, first ring channel 301 and second ring channel 302 have similar diameters, and third ring channel 303 has a different diameter. In some embodiments, second ring channel 302 and third ring channel 303 have similar diameters, and first ring channel 301 has a different diameter.

### INDUSTRIAL APPLICABILITY

Fuel injectors can be used to deliver fuel to a combustion chamber of an engine. Due to repetitive use in extreme temperature conditions, fuel injectors may undergo maintenance to repair or replace certain components of the fuel injector. During maintenance, gaskets such as O-rings may need to be removed from the fuel injector.

A cutting apparatus 100 may be provided to remove at least one gasket from the fuel injector. Some fuel injectors may have multiple gaskets. The cutting apparatus may provide a straightforward and efficient way to remove the gaskets. In addition, using the cutting apparatus to remove multiple gaskets can be safe and ergonomic.

FIG. 5 is a flowchart illustrating an exemplary method of removing a gasket from a fuel injector. At a step 401, a fuel injector, such as fuel injector 300, may be aligned with an alignment feature of a base platform of a cutting apparatus. For example, fuel injector 300 may be aligned with outer alignment feature 114 of base platform 118 of cutting apparatus 100. In some embodiments, fuel injector 300 may also be aligned with inner alignment feature 115 of base platform 118. During alignment, fuel injector 300 may be positioned onto outer alignment feature 114 and inner alignment feature 115. Outer alignment feature 114 and inner alignment feature 115 may both an indented rounded surface. The indented rounded surfaces of outer alignment feature 114 and inner alignment feature 115 may provide a surface to support fuel injector 300. By placing fuel injector 300 onto the indented rounded surfaces of outer alignment feature 114 and inner alignment feature 115, fuel injector 300 may be properly aligned with cutting apparatus 100 in the direction of actuation of actuator 103. In addition, inner alignment feature 115 may be a feature of inner position guide 113, and outer alignment feature 114 may be a feature of outer position guide 112.

At a step 402, an injector tip of the fuel injector may be inserted into an aperture of the cutting apparatus. For example, injector tip 305 of fuel injector 300 may be inserted into aperture 106 of axial position guide 119 of cutting apparatus 100. In some embodiments, injector tip 305 is inserted into insert aperture 107 of insert 116, in which insert 116 is positioned within aperture 106. Injector tip 305 may be inserted in an axial direction into aperture 107 until injector tip 305 contacts an axial stopping guide such as axial stopping guide 136. In some embodiments, when injector tip 305 contacts axial stopping guide 136, fuel injector 300 is properly aligned with cutting apparatus 100 in the axial direction.

At a step 403, a blade assembly may be actuated in which the blade assembly is in linear alignment with a gasket of a fuel injector. For example, first blade assembly 121 may be linearly aligned to first ring 311 of fuel injector 300. First blade assembly 121 may be actuated by actuator 103. In some embodiments, first blade assembly 121 may include first prong 131 and second prong 132. First prong 131 and second prong 132 may be spaced apart defining first slot 128. First prong 131 may have a first cutting portion 133 and second prong 132 may have a second cutting portion 134. Additionally, first slot 128 may have a width greater than the diameter of the first ring channel 301 and smaller than the diameter of first ring 311. In some embodiments, first blade assembly 121 is driven in a downwards direction by actuator 103.

In some embodiments, actuator 103 is activated by engaging an activation button, such as activation button 214. Activation button 214 may be connected to actuator 103. Additionally, activation button 214 may be a button or switch. In some embodiments, actuator 103 is activated by two activation buttons 214, in which both activation buttons 214 are required to be engaged simultaneously to activate actuator 103. In such embodiments, the two activation buttons 214 may be spaced sufficiently far apart from one another to require an operator to use two hands to activate actuator 103.

In some embodiments, actuator 103 is immediately halted by engaging a button, such as emergency button 213. Engaging emergency button 213 may stop actuator 103 from driving first blade assembly 121.

At a step 404, a gasket may be sheared by actuating a blade assembly past the gasket. For example, by actuating first blade assembly 121 past first ring 311, first blade assembly 121 may shear first ring 311. In some embodiments, first cutting portion 133 of first prong 131 and second cutting portion 134 of second prong 132 shears first ring 311. Shearing first ring 311 may cause first ring 311 to fall off of fuel injector 300.

In some embodiments, steps 403 and 404 may be repeated for additional gaskets. In some embodiments, steps 403 and 404 may remove additional gaskets at the same time by using multiple blade assemblies. For example, second ring 312 and third ring 313 of fuel injector 300 may be linearly aligned to second blade assembly 122 and third blade assembly 123 of cutting apparatus 100, respectively. Furthermore, second ring 312 and third ring 313 may be sheared by second blade assembly 122 and third blade assembly 123, respectively. Second blade assembly 122 and third blade assembly 123 may each have two prongs featuring cutting portions. In addition, first blade assembly 121, second blade assembly 122 and third blade assembly 123 may all be configured to be driven by actuator 103.

At a step 405, the sheared gaskets may be deposited into a receptacle. For example, after step 404, first ring 311 is sheared off of fuel injector 300 and may fall downwards from fuel injector 300. In some embodiments, the sheared first ring 311 falls through outer base opening 108. After falling through outer base opening 108, the sheared first ring 311 may be deposited into receptacle 210. Receptacle 210 may provide a container to receive sheared gaskets. In embodiments where cutting apparatus shears multiple gaskets, some of the gaskets may fall through inner base opening 109 and into receptacle 210.

The preceding detailed description is merely exemplary in nature and is not intended to limit the invention or the application and uses of the invention. The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A cutting apparatus for removing gaskets from a fuel injector, the cutting apparatus comprising:
a blade platform;
a base platform parallel and spaced apart from the blade platform;
an actuator for actuating the blade platform towards the base platform;
a first blade assembly coupled to the blade platform, the first blade assembly including
a first prong extending away from the blade platform, the first prong having a first cutting portion,
a second prong extending away from the blade platform, the second prong having a second cutting portion, the second prong spaced apart from the first prong,
a first slot between the first prong and the second prong;
an outer position guide extending from the base platform; and
an axial position guide adjacent and perpendicular to the base platform, the axial position guide spaced apart from the outer position guide, the axial position guide having an aperture defining an axis.

2. The cutting apparatus of claim 1, further comprising
an inner position guide extending from the base platform, the inner position guide spaced apart from the outer position guide.

3. The cutting apparatus of claim 2, further comprising
a second blade assembly coupled to the blade platform, the second blade assembly spaced apart from the first blade assembly, and the second blade assembly having at least two prongs defining a second slot.

4. The cutting apparatus of claim 3, further comprising
a third blade assembly coupled to the blade platform, the third blade assembly spaced apart from the second blade assembly, and the third blade assembly having at least two prongs defining a third slot.

5. The cutting apparatus of claim 4, wherein
the first blade assembly is located between the outer position guide and the inner position guide, the second blade assembly is located between the outer position guide and the inner position guide, and the third blade assembly is located between the inner position guide and the axial position guide.

6. The cutting apparatus of claim 1, wherein the outer position guide includes a rounded indented surface.

7. The cutting apparatus of claim 6, wherein the rounded intended surface is aligned to the aperture.

8. The cutting apparatus of claim 1, wherein the first blade assembly is located a predetermined distance from the axis.

9. The cutting apparatus of claim 1, further comprising an outer base opening extending through the base platform, the outer base opening located adjacent the outer position guide.

10. A method of removing annular gaskets from a fuel injector, the method comprising aligning the fuel injector with an outer position guide of a cutting apparatus, the fuel injector having a first gasket channel enclosed by a first annular gasket;
inserting an injector tip of the fuel injector into an aperture of the cutting apparatus;
actuating a first blade assembly in linear alignment with the first annular gasket, the first blade assembly having a first prong and a second prong spaced apart from the first prong defining a first slot; and
shearing the first annular gasket by actuating the first prong and second prong of the first blade assembly past the first annular gasket.

11. The method of claim 10, further comprising
depositing the sheared first annular gasket through a base opening within the base platform into a receptacle.

12. The method of claim 10, further comprising inserting the injector tip into the aperture of the cutting apparatus until the injector tip contacts an axial stopping guide.

13. The method of claim 10, wherein the first annular gasket is sheared by actuating a first cutting portion of the first prong and a second cutting portion of the second prong past the first annular gasket.

14. The method of claim 10, further comprising
actuating a second blade assembly in linear alignment with a second annular gasket, the second blade assembly having two prongs spaced apart defining a second slot; and
shearing the second annular gasket by actuating the two prongs of the second blade assembly past the second annular gasket.

15. The method of claim 14, further comprising
actuating a third blade assembly in linear alignment with a third annular gasket, the third blade assembly having two prongs spaced apart defining a third slot; and
shearing the third annular gasket by actuating the two prongs of the third blade assembly past the third annular gasket.

16. The method of claim 10, wherein the first blade assembly is actuated by an actuator, and the actuator is activated by engaging an activation button.

17. The method of claim 16, wherein the actuator is activated by engaging two activation buttons simultaneously.

18. A gasket removal machine for removing O-rings from a fuel injector, the gasket removal machine comprising:
a blade platform;
a base platform parallel and spaced apart from the blade platform;
an outer position guide extending from the base platform, the outer position guide spaced apart from the axial position guide along the axis;
an axial position guide adjacent and perpendicular to the base platform, the axial position guide having an aperture defining an axis;
an actuator configured to actuate the blade platform a predetermined distance towards the base platform;
a first cutting tool coupled to the blade platform and located a predetermined distance from the axis, the first cutting tool including
a first prong extending away from the blade platform, the first prong having a first cutting portion,
a second prong extending away from the blade platform, the second prong having a second cutting portion, the second prong spaced apart from the first prong,
a first slot between the first prong and the second prong;
an enclosure including a front panel having an enclosure opening; and
a receptacle for receiving removed O-rings.

19. The gasket removal machine of claim 18, further comprising
a second cutting tool coupled to the blade platform, the second cutting tool spaced apart from the first cutting tool, and the second cutting tool having at least two prongs defining a second slot.

20. The gasket removal machine of claim 18, further comprising
a third cutting tool coupled to the blade platform, the third cutting tool spaced apart from the second cutting tool, and the third cutting tool having at least two prongs defining a third slot.
